(19) United States
(12) Patent Application Publication
(10) Pub. No.: US 2017/0159272 A1
(43) Pub. Date: Jun. 8, 2017

(54) SANITARY FITTING, PREFERABLY A WASHSTAND FAUCET OR KITCHEN FAUCET

(71) Applicant: Hansgrohe SE, Schiltach (DE)

(72) Inventors: Klaus Butzke, Schiltach (DE); Daniel Philipp Dieterle, Wolfach-Kirnbach (DE); Ulrich Kinle, Schenkenzell (DE); Sven Kleinwaechter, Steinach (DE); Markus Woehrle, Schiltach (DE)

(21) Appl. No.: 15/368,000

(22) Filed: Dec. 2, 2016

(30) Foreign Application Priority Data
Dec. 7, 2015 (DE) 102015224425.3

(51) Int. Cl. E03C 1/04; B05B 1/16; E03C 1/08

(52) U.S. Cl. CPC E03C 1/0405; E03C 1/08; B05B 1/1645; B05B 1/1663; B05B 1/169

(57) ABSTRACT

The invention relates to a sanitary fitting, in particular a washstand faucet or a kitchen faucet, comprising a faucet housing (2) including a water inlet and a water outlet.

The sanitary fitting according to the invention comprises a jet selector device (7) which is displaceably held downstream of the water outlet of the faucet housing and includes at least two different jet-forming bodies (6a, 6b, 6c) which are capable of being transferred selectively into or off a fluid communication with the water outlet by an actuation move of the jet selector device.

Use for kitchen sink showers, for example.

The invention relates to a sanitary fitting, in particular to a washstand faucet or kitchen faucet, having a faucet housing including a water inlet and a water outlet.

A sanitary fitting that has a faucet housing and a mixing cartridge is known from the unexamined publication DE 10 2006 042 626 A1. An outlet for dispensing mixed water above a washstand protrudes from the faucet housing. The outlet has two different outlet openings. The outlet is horizontally pivoted in order to switch from one outlet opening to the other outlet opening.

The invention is based on the technical issue of providing a sanitary fitting of the type mentioned at the outset that is advantageously capable of selectively dispensing infed fluid in at least two dissimilar jet forms.

The invention achieves this technical object by providing a sanitary fitting having the features of claim 1. Advantageous and preferred design embodiments of the invention are the subject matter of the further claims. The wording of the claims by way of explicit reference thereto is herewith incorporated in the contents of the specification.

The sanitary fitting according to the invention has a jet selector device which is displaceably held downstream of the water outlet of the faucet housing, and includes at least two different jet-forming bodies which are capable of being transferred selectively into or out of fluid communication with the water outlet by an actuation movement of the jet selector device. Thus, by an actuation movement of the jet selector device a selected jet-forming body is moved to a position in which the latter may be perfused by a fluid flow. It is advantageous herein that the jet selector device may be composed of and constructed in a compact manner from relatively simple components. In this way, the jet selector device may be a plate-shaped or cylindrical component, for example, which is displaceable in a guide of the faucet housing. For selecting a desired jet-forming body, the jet selector device is moved in relation to the water outlet of the faucet housing. Upon selection of a jet-forming body, that is to say when the latter has been brought into fluid communication with the water outlet and thus into the flow path of the water flow, the former may be perfused by the water flow exiting from the water outlet. The operational actuation may be selectively performed directly on the jet selector device, or indirectly, for example by way of a lever or a rotary wheel or an electrically activatable lifting cylinder.

In a design embodiment of the invention, the jet-forming bodies are of different jet types. On account thereof, the jet-forming bodies may shape the perfusing fluid flow, typically a water flow, in dissimilar manners, leading to dissimilar jet-exit characteristics of the exiting fluid. Herein, all conventional jet forms, in particular punctiform jets, annular jets, wide or narrow jet forms, needle jets, surge jets, massaging jets, and all variations thereof, are possible in principle.

In a design embodiment of the invention, the jet selector device is displaceable in a translational manner. To this end, a jet selection plate is mounted so as to be displaceable on the faucet housing. The jet-forming bodies that are disposed on the jet selection plate are then successively displaceable into a flow path of the water flow by linear repositioning of the jet selector device. It is also possible for a plurality of translational movements in various directions to be carried out sequentially with the jet selector device. The jet-forming bodies may be disposed in one alignment or row, respectively, and the jet selector device may be displaceable along only one axis; however, there may also be a plurality of parallel or non-parallel rows of jet-forming bodies present, which accordingly are repositionable along a plurality of parallel or non-parallel axes.

In another design embodiment of the invention, the jet selector device includes a cylindrical jet selection revolver on which the jet-forming bodies are disposed on an end side. The jet selector device is then repositionable in a rotary manner. The jet-forming bodies that are disposed on the jet selector device are successively repositioned into the flow path of the water flow by rotating the jet selection revolver about a longitudinal axis, for example the central longitudinal axis of the latter. If required, the jet selection revolver in a corresponding design embodiment may additionally be repositionable in a translational manner.

In an embodiment of the invention, the jet selector device has a catch mechanism. The catch mechanism serves for latching the jet selector device in pre-set positions in which a respective jet-forming body is selected and is perfused by a water flow.

In an embodiment of the invention, the jet selector device has jet chambers which are sealed in relation to one another. Sealing the jet chambers prevents a plurality of jet chambers being simultaneously perfused by the water flow. It is thus ensured that only that jet-forming body that has been selected by the operator is perfused at all times. In one embodiment of the invention, there may also be a multiple-channel water outlet having a plurality of individual water outlets from the faucet housing, and the possibility of repositioning seals so as to prevent perfusion of non-selected water outlets.

In an embodiment of the invention, the faucet housing has a plate-shaped housing outlet part with a flat channel structure, and a water outlet issuing from the flat channel structure on a bottom side. The flat channel structure permits a low installation height of the sanitary fitting. In addition, a wide water flow can be formed, as required, by way of a wide flat channel structure.

Advantageous embodiments of the invention are illustrated in the drawings and are described hereunder. In the drawings:

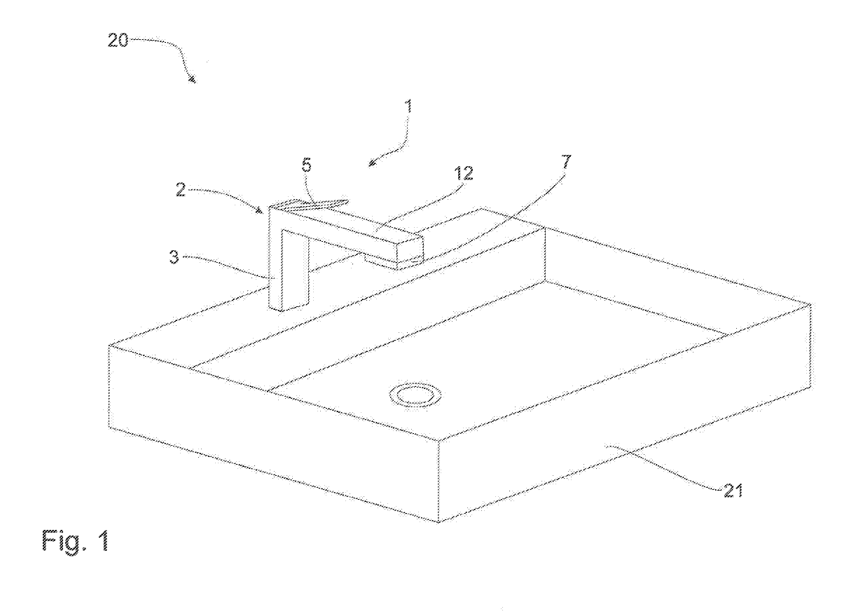

FIG. 1 shows a schematic perspective view of a washstand having a sanitary fitting according to the invention.

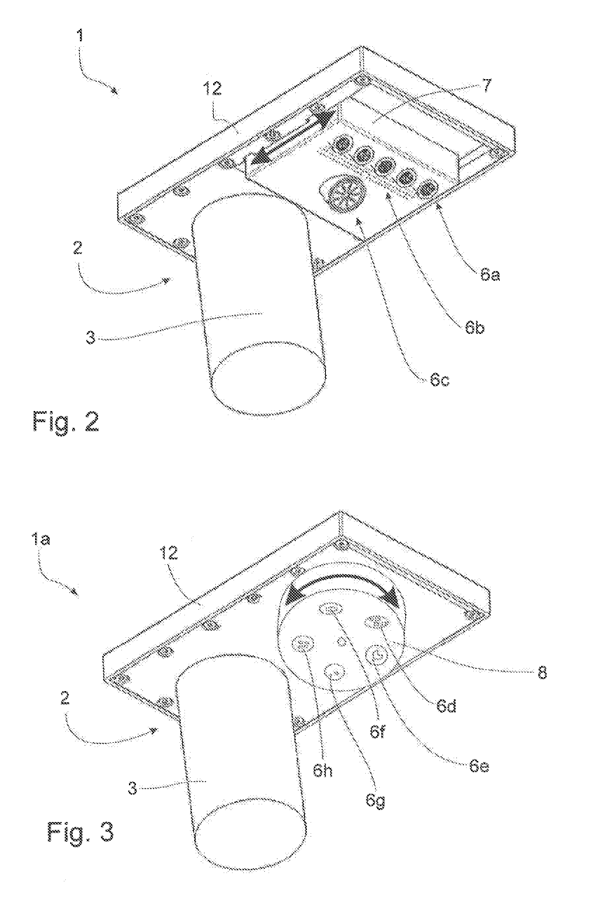

FIG. 2 shows a perspective view of a sanitary fitting according to the invention, having a jet selection plate.

FIG. 3 shows a perspective view of a sanitary fitting according to the invention, having a jet selection revolver.

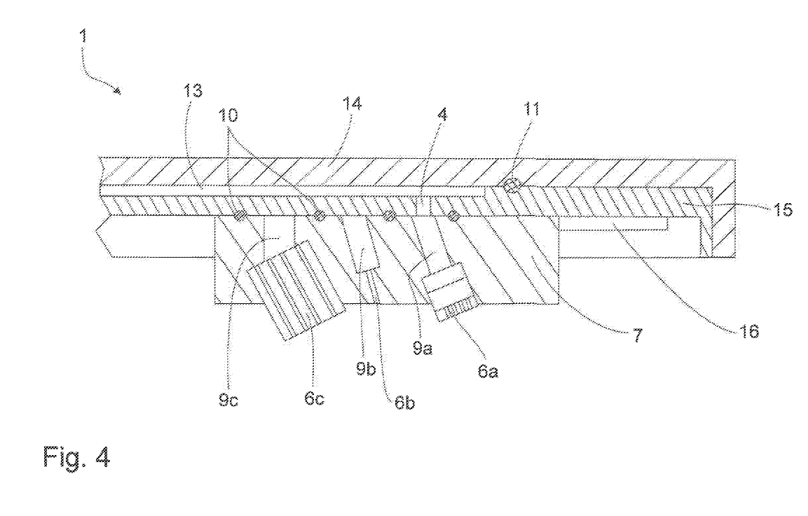

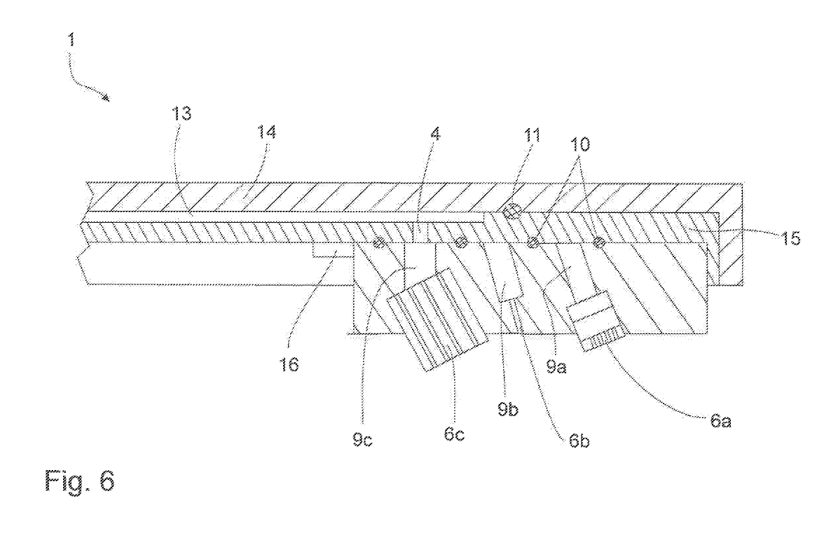

FIGS. 4 to 6 show fragmented sectional illustrations of the sanitary fitting of FIG. 2, having various positions of the jet selection plate.

A washstand structure 20 having a washbasin 21 and a sanitary fitting 1 is illustrated in FIG. 1. The sanitary fitting 1 is fastened to an upper side of the washbasin 21. On a lower side of the washbasin 21, the sanitary fitting 1 is connected to at least one water line. The sanitary fitting 1 has a faucet housing 2 having a main body 3 that is fastened to the washbasin 21, and a housing outlet part 12 that protrudes from the main body 3 in a substantially horizontal manner above the washbasin region. A selector lever 5 is attached to the faucet housing 2 in an upper region of the sanitary fitting 1, said selector lever 5 potentially serving for selecting a temperature and/or an amount of fluid. A repositionable jet selector device in the form of a jet selection plate 7 is disposed in a region on a lower side of the housing outlet part 12, so as to be distal from the faucet housing 2.

The sanitary fitting is schematically illustrated in more detail in FIG. 2. The jet selection plate 7 is disposed so as to be displaceable in a linear manner on the lower side of the housing outlet part 12 that protrudes from the main body 3 of the faucet housing 2. Three jet-forming bodies 6a, 6b, 6c are disposed on a lower side of the jet selection plate 7. The jet-forming body 6a of the embodiment of the sanitary fitting 1 that is shown in FIG. 2 forms a multiple soft jet having five pearly jets, the jet-forming body 6b forms a fine-needle jet having a multiplicity of fine jets, and the jet-forming body 6c forms a monojet. By displacing the jet selection plate 7 along a longitudinal axis of the housing outlet part 12, as can be seen by means of the double arrow according to FIG. 2, in each case one of the jet-forming bodies 6a, 6b, 6c may be selected as will yet be explained in more detail hereunder.

The variant illustrated in FIG. 3, having a sanitary fitting 1a, corresponds substantially to the sanitary fitting 1 of FIG. 2. However, FIG. 3 shows a jet selector device which is repositionable in rotary manner, in the form of a cylindrical jet selection revolver 8. The rotation direction of the jet selection revolver 8 about the longitudinal cylinder axis thereof is indicated by means of a double arrow. The jet selection revolver 8 on the lower end side thereof has five jet-forming bodies 6d, 6e, 6f, 6g, 6h. The jet-forming bodies 6d, 6e, 6f, 6g, 6h are successively brought into fluid communication with a water outlet 4 of the housing outlet part 12 by means of a rotary movement of the jet selection revolver 8 about the central axis thereof.

FIGS. 4 to 6 each show fragmented sectional illustrations of the housing outlet part 12 of the sanitary fitting 1 of FIG. 2, having an external wall 14, an internal wall 15, and a flat channel structure 13 lying therebetween. When viewed in an observation plane, the jet selection plate 7 is disposed below the internal wall 15, that is to say on a lower side of the housing outlet part 12. The jet selection plate 7 has three inboard jet chambers 9a, 9b, 9c, the three jet-forming bodies 6a, 6b, 6c being adjacent thereto downstream. The jet selection plate 7, depending on the initial position thereof, may be repositioned to the left and/or to the right. The water outlet 4 which remains stationary herein, by means of a latching assembly (not illustrated) of the jet selection plate 7 and of the housing outlet part 12 is brought precisely into fluid communication with the jet chambers 9a, 9b, 9c, and thus into fluid communication with the jet-forming bodies 6a, 6b, 6c of the jet selection plate 7. The jet selection plate 7 is guided in the external wall 14, in a way which is conventional per se, by way of guide grooves 16 and guide springs (not illustrated).

The individual jet chambers 9a, 9b, 9c by way of seals 10 are sealed in relation to one another, so as to prevent an overflow of the fluid from a selected jet chamber 9a, 9h, 9c into a further jet chamber 9a, 9b, 9c. The external wall 14 and the internal wall 15 are likewise sealed in relation to each other by way of a seal 11, so as to prevent leakages of the sanitary fitting 1a. To this end, the seal accordingly surrounds the rectangular flat channel along an approximately rectangular line.

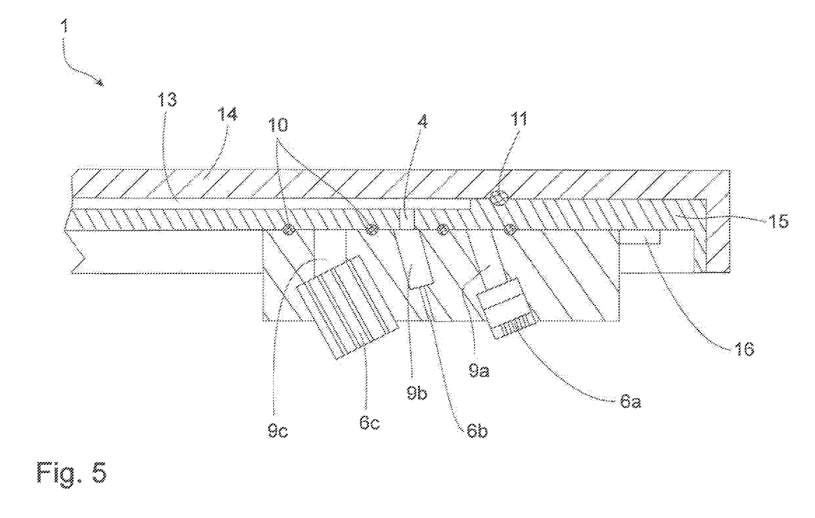

In FIG. 4, the jet selection plate 7 is illustrated in a first functional position in which a fluid communication between the flat channel structure 13, the water outlet 4, the jet chamber 9a, and the jet-forming body 6a has been set. In order for the jet selection plate 7 to be transferred into a second functional position as is illustrated in FIG. 5, the jet selection plate 7 is displaced by an operator by one latching position to the right. Herein, guide elements (not illustrated) of the jet selection plate 7 slide in guide grooves 16 of the external wall 14 of the housing outlet part 12 until the second functional position has been reached. In this position of the jet selection plate 7, the flat channel structure 13 by way of the water outlet 4 is in fluid communication with the jet chamber 9b and the jet-forming body 6b. Upon further repositioning of the jet selection plate 7 by one latching position to the right, a fluid communication between the flat channel structure 13, the water outlet 4, the jet chamber 9c, and the jet-forming body 6c is accordingly set. The jet-forming bodies 6b and 6a may be successively reselected by a movement in the opposite direction.

As becomes evident from the above description of exemplary embodiments, the invention advantageously provides a sanitary fitting by way of which infed fluid may be dispensed easily in dissimilar jet forms in that the jet selector device having the different jet-forming bodies is repositioned on the faucet housing so as to select the respective desired fluid jet.

1. A sanitary fitting, comprising
a faucet housing including a water inlet and a water outlet, and
a jet selector device,
wherein the jet selector device is displaceably held downstream of the water outlet of the faucet housing and comprises at least two different jet-forming bodies which are capable of being transferred selectively into and off a fluid communication with the water outlet by an actuation movement of the jet selector device.

2. The sanitary fitting according to claim 1, wherein the jet-forming bodies are of different jet types.

3. The sanitary fitting according to claim 1, wherein the jet selector device includes a translational displaceable jet selection plate.

4. The sanitary fitting according to claim 1, wherein the jet selector device includes a cylindrical jet selection revolver on which jet-forming bodies are disposed on a cylinder end face.

5. The sanitary fitting according to claim 1, wherein the jet selector device has a catch mechanism.

6. The sanitary fitting according to claim 1, wherein the jet selector device has jet chambers which are sealed against each other.

7. The sanitary fitting according to claim 1, wherein the faucet housing has a plate-shaped housing outlet part with a flat channel structure and a water outlet issuing from the flat channel structure on a bottom side.

8. The sanitary fitting according to claim 1, wherein the sanitary fitting is one of a washstand faucet and a kitchen faucet.

9. The sanitary fitting according to claim 2, wherein the jet selector device includes a translational displaceable jet selection plate.

10. The sanitary fitting according to claim 2 wherein the jet selector device includes a cylindrical jet selection revolver on which jet-forming bodies are disposed on a cylinder end face.
